(19) United States
(12) Patent Application Publication
(10) Pub. No.: US 2025/0024238 A1
(43) Pub. Date: Jan. 16, 2025

(54) RADIO FREQUENCY BAND AND ENERGY HARVESTING ARRANGEMENTS FOR OPERATION OF WIRELESS AMBIENT POWER (AMP) DEVICES

(71) Applicant: Cypress Semiconductor Corporation, San Jose, CA (US)

(72) Inventor: Rakesh Taori, McKinney, TX (US)

(73) Assignee: Cypress Semiconductor Corporation, San Jose, CA (US)

(21) Appl. No.: 18/514,964

(22) Filed: Nov. 20, 2023

Related U.S. Application Data
(60) Provisional application No. 63/512,832, filed on Jul. 10, 2023.

(51) Int. Cl. H04W 4/80

(52) U.S. Cl. CPC H04W 4/80; H04W 84/12

(57) ABSTRACT

A method includes transmitting, by an anchor wireless device over a first radio frequency (RF) band, a first wireless signal to a client wireless device. The client wireless device is an ambient power (AMP) device that harvests environmental energy. The first wireless signal includes a data packet requesting information from the client wireless device. The method further includes receiving, by the anchor wireless device over a second RF band, a second wireless signal from the client wireless device. The second wireless signal includes a data packet responding with the requested information.

### CLAIM OF PRIORITY

The present application claims the benefit under 35 U.S.C. § 119 (e) of U.S. Provisional Patent Application No. 63/512,832, filed Jul. 10, 2023, which is incorporated by this reference herein.

### TECHNICAL FIELD

This disclosure relates to wireless devices and, more specifically, to radio frequency (RF) band and energy harvesting arrangements for operation of wireless ambient power (AMP) devices.

### BACKGROUND

Radio frequency (RF) wireless devices have grown in type and capability. In some wireless local area networks (WLANs), anchor wireless devices such as routers and access points (APs) can be configured to track a location and optionally also a status of numerous client wireless devices that travel throughout a geographic area of the WLAN. Client wireless devices, such as wireless identification tags, are therefore duplicated throughout tracking systems. Some use cases include tagging containers of retail products traveling from and between warehouses and tagging luggage being transported from and between air transportation and within airports. Employing battery-powered identification tags for tracking can ensure reliable tracking by anchor wireless devices, particularly over large distances or that support significant data transmission, but are more expensive when duplicated for extensive tagging purposes. Employing ambient power (AMP) devices, which harvest energy from the environment, for tagging purposes is more cost effective, but may cause reliability issues due to operating with low and unpredictable amount of power. For example, AMP devices may have a difficult time communicating over a very large distance or transmitting very much data due to operating on low amounts of power.

### BRIEF DESCRIPTION OF THE DRAWINGS

FIG. 1A is a block diagram of an exemplary wireless network configured with RF band arrangements for downlink and uplink transmissions between an anchor wireless device and an AMP device according to various embodiments.

FIG. 1B is a block diagram of an exemplary wireless network configured with RF band arrangements for downlink and uplink transmissions between an anchor wireless device and an AMP device according to other embodiments.

FIG. 2 is a flow diagram of a method of configuring the wireless network to communicate over different RF bands (or at least different frequencies within the same RF band) as between downlink and uplink transmissions, respectively, according to an embodiment.

FIG. 3 is a block diagram of an exemplary wireless network configured with RF band arrangements for downlink and uplink transmissions that involve an intermediary network node device according to at least one embodiment.

FIG. 4 is a flow diagram of a method of configuring the wireless network to communicate over different RF bands and that involves the intermediary network node device according to at least one embodiment.

FIG. 5 is a block diagram of an exemplary wireless network similar to that of FIG. 3 in which a user of the network node device can see a location of the AMP device according to at least one an embodiment.

FIG. 6 is a flow diagram of a method of configuring the wireless network to communicate over different RF bands and that involves locating the AMP device using a network node device according to at least one embodiment.

FIG. 7 is a simplified block diagram of an example wireless device, which may represent any of the anchor or client wireless devices discussed herein according to various embodiments.

### DETAILED DESCRIPTION

The following description sets forth numerous specific details such as examples of specific systems, devices, components, methods, and so forth, in order to provide a good understanding of various embodiments of radio frequency (RF) band arrangements for operation of ambient power (AMP) devices. Some wireless devices AMP devices, e.g., AMP wireless clients, are simple wireless devices needing little processing and memory, and thus can operate with little power. These AMP devices harvest (or scavenge) energy out of the environment sufficient for brief and reduced processing. For example, AMP devices may communicate an identifier (ID) and/or other data being gathered by anchor wireless devices, such as routers and APs, from the AMP devices. Anchor wireless devices, which are stationary, may be so referenced within mesh networks because locations of anchor wireless devices are known, and thus are similarly referenced herein to be distinguished from mobile client wireless devices, such as AMP-based devices. In some cases, the known location is relative to a moving vehicle or the like, as some anchor wireless devices may have some level of mobility.

As discussed previously, employing AMP devices as mobile identifications tags (or similar AMP wireless clients) within a WLAN tracking system is difficult due to having to operate the AMP devices at low power. Further, typical communication between an anchor wireless device and a mobile client wireless device (e.g., in the WLAN-based system) occurs over the same RF band and often at the same frequency, leading to potential conflicts in networked communication between downlink (DL) communication to the AMP devices and the uplink (UL) communication from the AMP devices. Despite these challenges, AMP devices may be desired due to the large number of client wireless devices needed in the WLAN tracking system, e.g., for tagging and tracking numerous containers, crates, products, and the like.

To resolve these and other deficiencies with known approaches to employing AMP devices in WLAN-based systems, the present disclosure sets forth configuring and/or operating the anchor wireless devices and the AMP devices such that the AMP devices are energized for a limited purpose of triggering communication of limited data transmitted by the AMP devices to the anchor wireless devices. The present disclosure discusses several embodiments of arranging communication between the anchor wireless devices and the AMP devices (or AMP wireless clients) in which the AMP devices are energized in multiple different ways, power consumption by the AMP devices is minimized, e.g., via minimizing channel contention requirements, and the RF bands are configured such that UL transmissions can differ in RF band (or at least in frequency) from DL transmissions. Additionally, an energizing band or signal may be the same or different compared to the RF bands used for UL and DL transmission. Further, as will be discussed in more detail, various embodiments may be employed in which network node wireless devices within the WLAN can be tethered as an intermediary or function as a destination of data packets transmitted by the low-power AMP devices.

In at least one embodiment, a wireless network includes an anchor wireless device to transmit, over a first radio frequency (RF) band, a first wireless signal including a data packet requesting information. A client wireless device may be configured to harvest energy from an environment of the client wireless device, receive the first wireless signal, and parse the data packet. In these embodiments, the client wireless device transmits, over a second RF band, a second wireless signal to the anchor wireless device, where the second wireless signal includes a data packet responding with the requested information. In some embodiments, the second RF band operates at a lower frequency range than that of the first RF band. In other embodiments, the first RF band is the same as the second RF band, but the DL transmission and the UL transmission are over different frequencies with significant separation within that RF band. In other embodiments, the second RF band operates at a high frequency range than that of the first RF band, which may provide a wider bandwidth and thus also have separate power consumption benefits.

The present disclosure includes a number of advantages, including the ability to minimize power consumption by AMP devices employed as wireless client devices within a WLAN tracking system, providing many possible ways to energize the AMP devices, and different ways in which the DL and UL transmissions can be arranged to minimize RF band and/or frequency conflicts. Additional advantages will be apparent to those skilled in the art of WLAN-related tracking systems that employ AMP devices and are discussed further below.

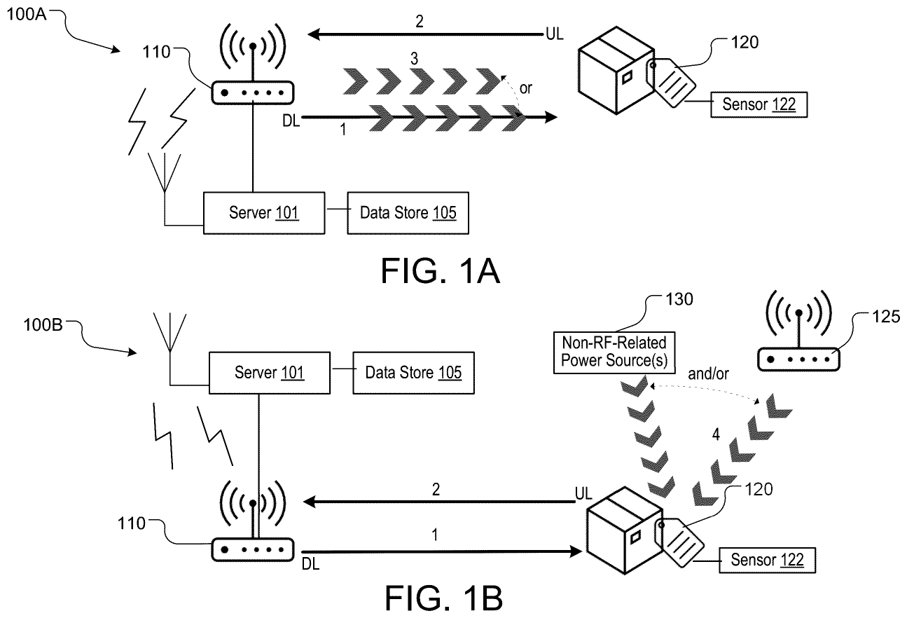

FIG. 1A is a block diagram of an exemplary wireless network 100A configured with RF band arrangements for downlink (DL) and uplink (UL) transmissions between an anchor wireless device 110 and an AMP device 120, e.g., client wireless device, according to various embodiments. In some embodiments, the anchor wireless device 110 is an access point, a router, a wireless hub, a mobile hotspot device, or a wireless (or cellular) base station or the like that is stationary. In various embodiments, the AMP device 120 is a wireless identification tag or a low-power client wireless device or AMP station (STA).

In some embodiments, the anchor wireless device 110 communicates to a WLAN server 101 to upload data to a cloud. In these embodiments, the WLAN server 101 includes or is coupled to a data store 105 of volatile or non-volatile memory, e.g., within cloud-based storage. In this way, data or information collected by the anchor wireless device 110 can be stored, by the WLAN server 101, in the data store 105 where the data can optionally be indexed against respective AMP devices (including the AMP device 120), e.g., in a database or the like. In various embodiments, the data or information collected and stored includes an identification and/or a location of the AMP device 120, temperature data, humidity data, pressure data, level data (e.g., level of fluid or gas within a container), and/or other data associated with an environment of the AMP device 120. In some embodiments, the data or information is a log or array of information to include a data history of the AMP device 120 that includes environmental data or information collected over time. The sensor-related data may be detected from a sensor 122 (or multiple sensors) included within or coupled to the AMP device 120.

In many embodiments, there are one or more anchor wireless devices and many client wireless devices, which are AMP devices, as disclosed herein. Ambient power (AMP) devices are energized by harvesting energy from RF signals (e.g., RF-related power sources) and/or from non-RF-related power sources. In various embodiments, harvested energy from RF-related power sources are from in-band RF power sources (e.g., within the same RF band being used for DL/UL transmissions) or out-of-band RF power sources (e.g., DL and UL transmissions take place in different RF bands compared to RF band being used for energy harvesting). In additional embodiments, as will be illustrated with reference to FIG. 1B, non-RF-related power sources include solar or photovoltaic cells (convert ambient sunlight into electricity), thermoelectric generators (convert temperature gradients into electricity), vibration energy harvesting using piezoelectric, electrostatic, and electromagnetic converters (convert mechanical vibrations from the environment into electricity), miniature wind turbines (convert ambient wind energy into electrical power), pressure differential energy harvesting, dynamos or wearable harvesters (convert human or animal motion into electrical energy), and other such energy-harvesting mechanisms.

With additional reference to FIG. 1A, in at least one embodiment, the anchor wireless device 110 transmits a first wireless signal (1), which is a DL transmission, over a first RF band to the AMP device 120. In some embodiments, the first wireless signal includes a data packet requesting information from the AMP device 120. The AMP device 110 may receive the first wireless signal and parse the data packet to determine the requested information.

In these embodiments, the AMP device 120 transmits a second wireless signal (2), which is an UL transmission, over a second RF band to the anchor wireless device 110 with a data packet with the requested information. In this way, the requested information or data (discussed previously) may be requested and received from the AMP device 120 through data packet exchange. In various embodiments, the anchor wireless device 110 generates the first wireless signal employing technology such as Wi-Fi®, Bluetooth®, Bluetooth® Low Energy, Ultra-Wideband (UWB), Z-Wave™, Zigbee®, LoRa™, Wi-SUN®, or other wireless protocol. In various embodiments, the AMP device 120 generates the second wireless signal employing technology such as Wi-Fi®, Bluetooth®, Bluetooth® Low Energy, Ultra-Wideband (UWB), Z-Wave™, Zigbee®, LoRa™, Wi-SUN®, or other wireless protocol.

In some embodiments, the first RF band for DL transmission differs from the second RF band used for UL transmission. In some embodiments, the second RF band operates at a lower frequency range than that of the first RF band, e.g., as low frequencies consume less power. Lower frequencies also exhibit smaller path losses compared to higher frequencies and, at the same power, the wireless signals can be adequately received and decoded at a farther distance and propagate through or around obstacles better compared to higher frequencies. Further, RF and circuit design at lower frequencies can be far less complex compared to being designed for at higher frequency operation, keeping costs low for the AMP devices.

In some embodiments, the second RF band operates at a higher frequency range than that of the first RF band, e.g., higher frequency operations deploy wider channel bandwidths, which in turn allow a transmission of the same number of user bytes and finish earlier. The AMP device 120 may then receive and/or transmit for a shorter period of time, conserving power and providing a separate power consumption benefit. Accordingly, use of a higher frequency range or a lower frequency range with the UL transmission (compared to the DL transmission) may involve a cost-benefit analysis that weighs these benefits as between higher or lower frequency ranges.

In other embodiments, the first RF band is the same as the second RF band, but the DL transmission and the UL transmission occur over different frequencies with significant separation (e.g., more than a few 100 megahertz (MHZ) within that same RF band. In these ways, both the technology and RF bands (or frequencies) can differ as between the DL/UL transmissions so that AMP devices can operate at lower power while avoiding frequency conflicts between the DL and UL transmissions.

In various embodiments, the first wireless signal (1), e.g., transmitted in the first RF band, is also an energizing RF signal, illustrated with thick directional indicators, from which the AMP device 120 harvests energy. In similar embodiments, the anchor wireless device 110 instead transmits a separate energizing RF signal (3) towards the AMP device 120, but this separate energizing RF signal (3) is also within the first RF band, e.g., is not necessarily the same as the first wireless signal (1), but may be close in frequency. In alternative embodiments, the separate energizing RF signal (3) is transmitted over the second RF band, e.g., of the UL transmission, or is transmitted over an entirely different third RF band. Accordingly, in differing embodiments, the energizing RF signal (3) is sent over the first RF band, the second RF band, or the third RF band. For example, in some embodiments by way of example, the first RF band is 5.0 gigahertz (GHz), the second RF band may be 2.4 GHZ, and the third RF band may be 5.0 or 6.0 GHZ, where the third RF band may also be employed by the anchor wireless device 110 to communicate with other mobile stations (STA). In embodiments, any energizing signal discussed herein may be RF or non-RF, may be included in one or more RF band, and may be sent towards AMP devices 120 in anticipation of transmission so the AMP devices 120 are powered to respond to transmissions.

FIG. 1B is a block diagram of an exemplary wireless network 100B configured with RF band arrangements for DL and UL transmissions between the anchor wireless device 110 and the AMP device 120 according to other embodiments. In some embodiments, the anchor wireless device 110 does not transmit the energizing RF signal. For example, in other embodiments, the wireless network 100B further includes a second anchor wireless device 125 and/or non-RF-related power sources 130 that provide RF power and/or non-RF power, respectively, from which the AMP device 120 harvests energy (e.g., from power sources other than from the anchor wireless device 110 associated with the DL/UL transmissions). Possible non-RF-related power sources were previously discussed. In some embodiments, the second anchor wireless device is a cellular base station operating in licensed or shared frequency bands.

TABLE 1

| Energizing AMP STAs | DL Transmissions | UL Transmissions | |
|---|---|---|---|
| (Signal 3 or 4) | (Signal 1) | (Signal 2) | Notes: |
| Band X | Band X | Band X | RF band for energy |
| (e.g., 900 MHz) | (e.g., 900 MHz) | (e.g. 900 MHz) | harvesting same as the RF |
| | | | band used for DL/UL |
| Band X | Band Y | Band Y | RF band for energy |
| (e.g. 900 MHz) | (e.g. 2.4 GHz) | (e.g. 2.4 GHz) | harvesting different from |
| | | | RF band used for DL/UL |
| Band X | Band X | Band Y | DL/UL on different bands; |
| (e.g. 900 MHz) | (e.g. 5 GHz) | (e.g. 900 MHz) | RF band for energizing is |
| | | | same as RF band for DL |
| Band X | Band Y | Band X | DL/UL on different bands; |
| (e.g. 2.4 GHz) | (e.g. 6 GHz) | (e.g. 2.4 GHz) | RF band for energizing is |
| | | | same as RF band for UL |
| Band X | Band Y | Band Z | All 3 bands are different |
| (e.g. 2.4 GHz) | (e.g. 5 GHz) | (e.g. 900 MHz) | |

In at least some embodiments, the second anchor wireless device 125 transmits an energizing RF signal (4) towards the client wireless device from which the client wireless device harvests energy. In various embodiments, the energizing RF signal (4) is transmitted over one of the first RF band, the second RF band, or a third RF band. In some embodiments, the energizing RF signal (4) is transmitted as a continuous wave (CW) or using technology including Bluetooth®, Bluetooth® Low Energy, Wi-Fi®, or Zigbee®. In further embodiments, the energizing signals (1) or (3) discussed with reference to FIG. 1A are combined with the energizing RF signal (4) of FIG. 1B. Further, non-RF-related energy harvesting may be employed alone or in combination with RF-related energy harvesting. Table 1 summarizes the different combinations of RF bands for DL/UL transmissions and energizing RF signals associated with the embodiments explained above with reference to FIGS. 1A-1B. The example frequencies provided after the respective RF bands are by way of example only and are not meant to be limiting, as the different frequencies can vary widely and may depend on different technology and protocols now in existence or yet to be developed. For example, in addition to 900 MHZ, 2.4 GHZ, 5 GHZ, and 6 GHz, millimeter wireless also operates in the 57-71 GHz range and any of the RF bands listed in Table 1 could also be within the millimeter wireless range of operation.

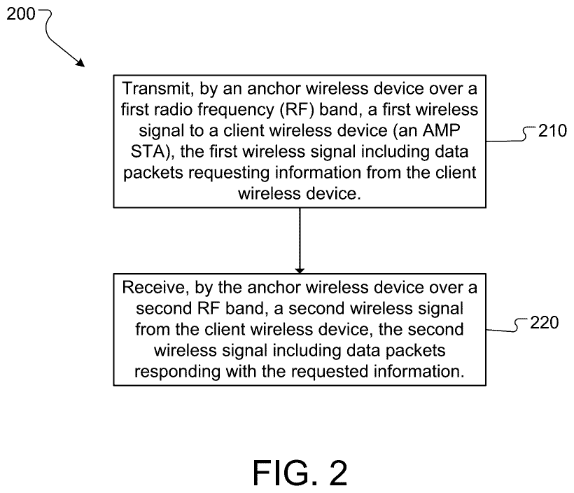

FIG. 2 is a flow diagram of a method 200 of configuring the wireless network to communicate over different RF bands (or at least different frequencies within the same RF band) as between downlink and uplink transmissions, respectively, according to an embodiment. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the anchor wireless device 110, e.g., processing logic of the anchor wireless device 110.

At operation 210, the processing logic transmits, over a first RF band, a first wireless signal to a client wireless device. In some embodiments, the client wireless device is an ambient power (AMP) device that harvests environmental energy. In some embodiments, the first wireless signal includes a data packet requesting information from the client wireless device.

At operation 220, the processing logic receives, over a second RF band, a second wireless signal from the client wireless device. In some embodiments, the second wireless signal includes a data packet responding with the requested information. In various embodiments, the requested information includes an identification of the client wireless device, security credentials, a location of the client wireless device, temperature data, pressure data, and/or environmental-related data associated with the environment of the client wireless device.

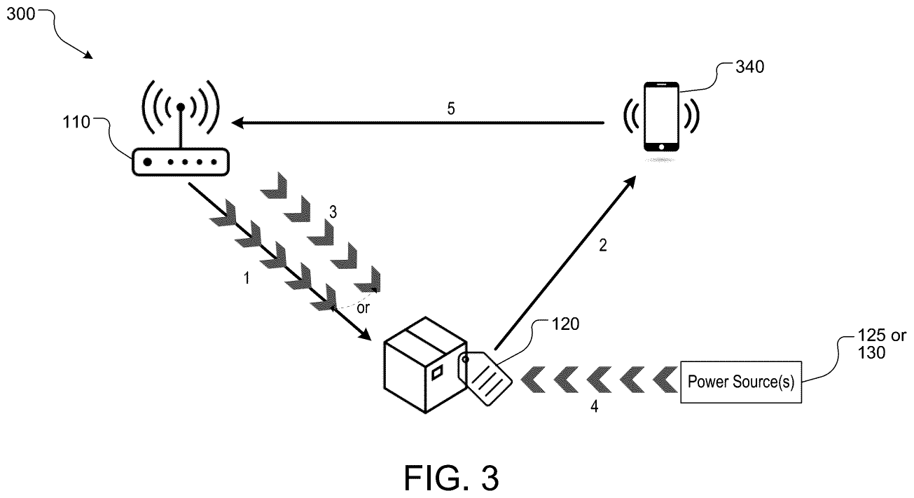

FIG. 3 is a block diagram of an exemplary wireless network 300 configured with RF band arrangements for DL and UL transmissions that involve an intermediary network node device 340 according to at least one embodiment. In these embodiments, the AMP device 120 can still be energized by any number of RF signals, e.g., the first wireless signal (1), the third wireless signal (3), or a fourth wireless signal (4) from the second anchor wireless device 125. As was discussed previously, non-RF-related power sources 130 may also energize or power the AMP device 120.

In these embodiments, the AMP device 120 does not have enough power to transmit all the way to the anchor wireless device 110. Thus, in some embodiments, the AMP device 120 transmits the second wireless signal (2), which is an UL transmission, over the second RF band to the network node device 340 that is located closer to the AMP device 120. Although illustrated as a mobile (or smart) phone, the network node device 340 may be a relay device, a mesh node device, or battery-powered device such as a mobile phone, a tablet, a laptop, a wearable device such as a watch or glasses, or other wireless mobile device. In some embodiments, the network node device 340 is also AC-powered, such as with the relay device, mesh node device, and/or the laptop. In these embodiments, the network node device 340 is assumed to be in the same WLAN as that of the anchor wireless device 110 and the AMP device 120.

With further reference to FIG. 3, in disclosed embodiments, the network node device 340 transmits the data packet via a fifth wireless signal (5) to the anchor wireless device 110. In this way, the data packet with the requested information is still delivered to the anchor wireless device 340, albeit through the battery-powered wireless device 340. In differing embodiments, the fifth wireless signal (5) is transmitted over the first RF band, the second RF band, or a third RF band, similarly as to discussed with reference to the second wireless signal (2) in FIGS. 1A-1B and Table 1. In various embodiments, the network node device 340 generates the second wireless signal employing technology such as Wi-Fi®, Bluetooth®, Bluetooth® Low Energy, Ultra-Wideband (UWB), Z-Wave™, Zigbee®, LoRa™, Wi-SUN®, or other wireless protocol.

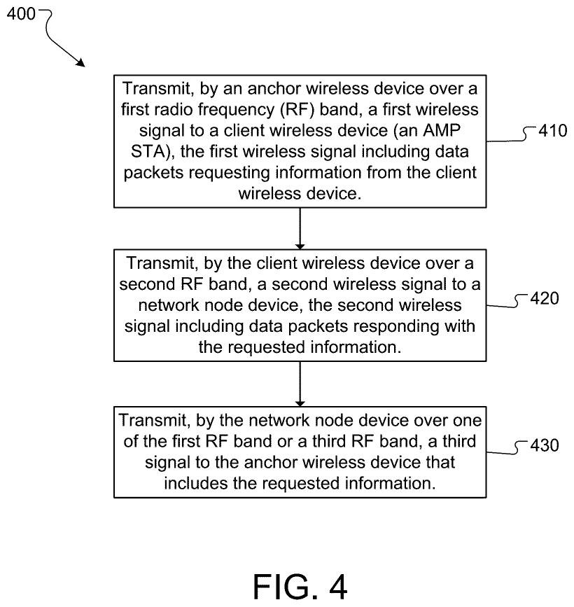

FIG. 4 is a flow diagram of a method 400 of configuring the wireless network 300 to communicate over different RF bands and that involves the intermediary network node device 340 according to at least one embodiment. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the wireless network 300, e.g., processing logic of the anchor wireless device 110, the AMP device 120, and of the network node device 340.

At operation 410, the anchor wireless device transmits, over a first radio frequency (RF) band, a first wireless signal to a client wireless device. In some embodiments, the client wireless device is the AMP device 120 that harvests environmental energy. In some embodiments, the first wireless signal includes a data packet requesting information from the client wireless device.

At operation 420, the client wireless device transmits, over a second RF band, a second wireless signal to the network node device 340. In some embodiments, the second wireless signal includes a data packet responding with the requested information.

At operation 430, the network node device 340 transmits, over one of the first RF band or a third RF band, a third wireless signal to the anchor wireless device that includes the requested information received from the client wireless device.

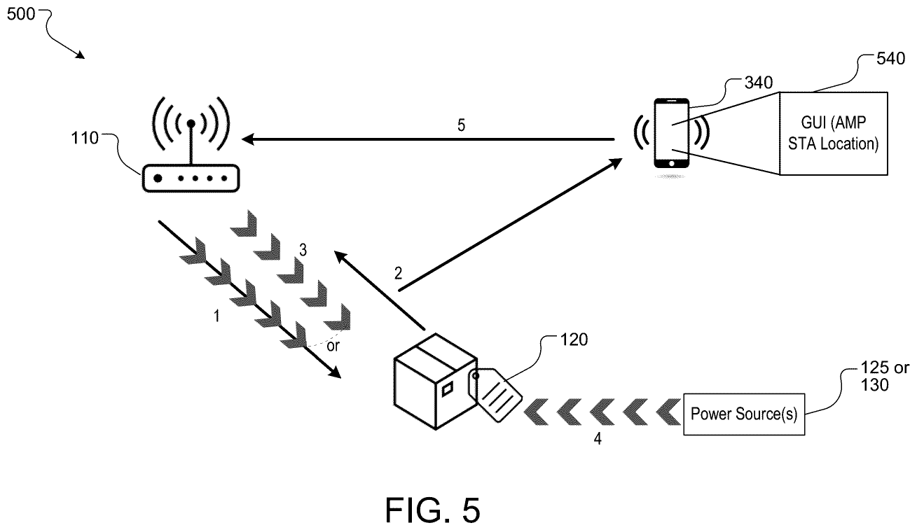

FIG. 5 is a block diagram of an exemplary wireless network 500 similar to the wireless network 300 of FIG. 3 in which a user of the network node device 340 can see a location of the AMP device 120 according to at least one embodiment. In these embodiments, the network node device 340 displays the location (and optionally other status information or data received from the AMP device 120) on a graphical user interface (GUI) 540 of the network node device 340. In at least some embodiments, the network node device 340 transmits an acknowledgement to the anchor wireless device 110 on behalf of the AMP device 120 that has insufficient power to do so, e.g., to complete the original DL transmission so that the anchor wireless device 110 will stop retransmitting the first wireless signal.

In these embodiments, imagine that the AMP device 120 is an automatic key fob useable to access and sometimes to also operate a vehicle. For example, the key fob may be attached to one or more keys that enable operation of the vehicle and the network node device 340 may be a smartphone carried by a user looking for the misplaced automatic key fob (and any attached keys). Upon viewing the location on the GUI 540, the user can locate and retrieve the automatic key fob based on the indicated location.

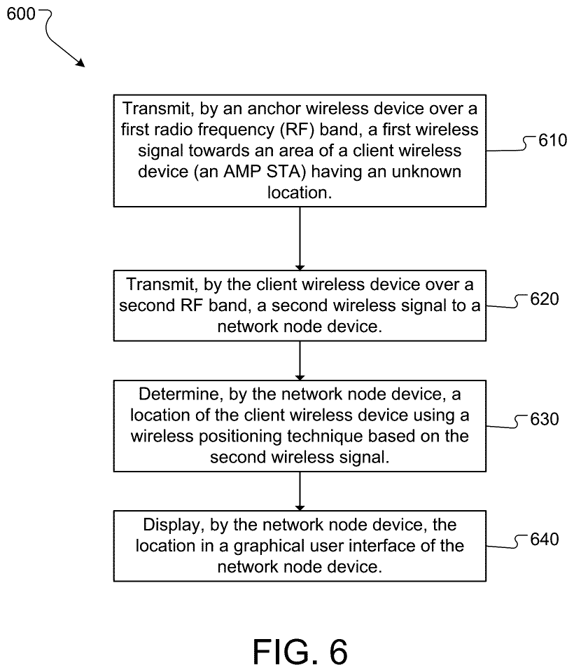

FIG. 6 is a flow diagram of a method 600 of configuring the wireless network to communicate over different RF bands and that involves locating the AMP device using a network node device according to at least one embodiment. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the wireless network 300, e.g., processing logic of the anchor wireless device 110, the AMP device 120, and the network node device 340.

At operation 610, the anchor wireless device 110 transmits, over a first radio frequency (RF) band, a first wireless signal towards an area of a client wireless device having an unknown location, e.g., such as the key fob scenario discussed with reference to FIG. 5. In some embodiments, the client wireless device is the AMP device 120 that harvests environmental energy. In some embodiments, the first wireless signal includes a data packet requesting a location of (or other information associated with) the client wireless device.

At operation 620, the client wireless device transmits, over a second RF band, a second wireless signal to the network node device 340. In some embodiments, the second wireless signal is a regular uplink (UL) transmission that is intercepted by the network node device 340.

At operation 630, the network node device 340 determines a location of the client wireless device using a wireless positioning technique based on the second wireless signal. In some embodiments, the wireless positioning technique is a Wi-Fi®-based positioning method including receiver signal strength indicator (RSSI)-based triangulation, trilateration, angle of arrival (AoA), time of arrival (ToA), fine timing measurement (FTM), scene analysis or fingerprinting, or a combination of these methods to include additional positioning techniques not specifically listed.

At operation 640, the network node device 340 displays the location in a graphical user interface of the network node device 340, e.g., which may be a wireless mobile device. In a further, optional operation, the network node device 340 transmits an acknowledgement to the anchor wireless device 110 on behalf of the client wireless device that has insufficient power to do so.

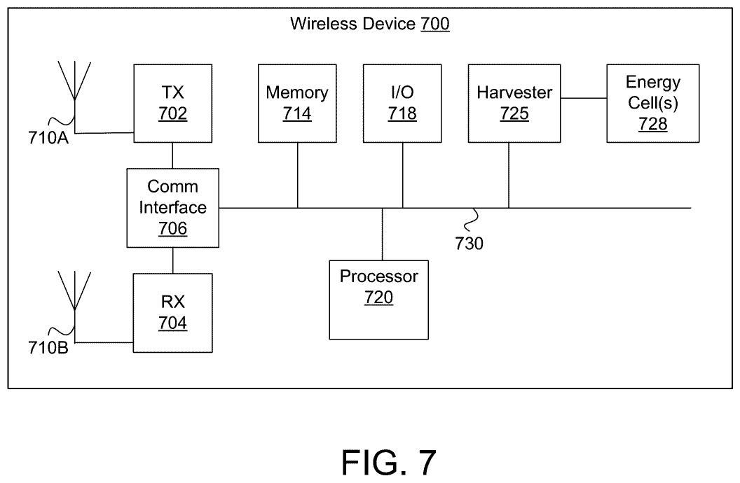

FIG. 7 is a simplified block diagram of an example wireless device 700, which may represent any of the anchor wireless device 110 or client wireless devices discussed herein according to various embodiments. For example, the client wireless devices may include the AMP device 120 and/or the network node device 340. In at least some embodiments, the wireless device 700 includes, but is not be limited to, a transmitter 702 or TX (e.g., a WLAN transmitter), a receiver 704 or RX (e.g., a WLAN receiver), a communications interface 706, a TX antenna 710A coupled to the transmitter 702, an RX antenna 710B coupled to the receiver 704, a memory 714, one or more input/output (I/O) devices 718 (such as a display screen, a touch screen, a keypad, and the like), a processor 720, an energy harvester 725, and energy cells 728. These components can all be coupled to a communications bus 730. In some embodiments, aspects of the communication interface 706 work with the processor 720 to perform operations or that function as a processing device of the wireless device 700. In some embodiments, there is a single antenna and multiplexing logic to switch use of the antenna between the TX and RX. In some embodiments, the anchor wireless device 110 has no energy harvester, and instead has a battery and/or is AC-powered.

In at least some embodiments, the memory 714 includes storage to store instructions executable by the processor 720 and/or data generated by the communication interface 706. In various embodiments, frontend components such as the transmitter 702, the receiver 704, the communication interface 706, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-Wave™, Zigbee®, LoRa™, Wi-SUN®, or other wireless protocol. While some of the protocols may also be referred to as personal area network (PAN) technology, for simplicity, all are broadly referred to as WLAN technology. Future protocols are also envisioned.

In various embodiments, the communications interface 706 is integrated with the transmitter 702 and the receiver 704, e.g., as a frontend of the wireless device 701. The communication interface 706 may coordinate, as directed by the processor 720, to request/receive packets from other wireless devices or those that reflect off of objects. The communications interface 706 can further process data symbols received by the receiver 704 in a way that the processor 720 can perform further processing, including identifying and parsing data packets received within the wireless signals.

In various embodiments, the energy harvester 725 performs operations disclosed herein in order to capture electromagnetic or RF signals and other types of non-RF energy, e.g., light, temperature gradients, pressure differential, mechanical vibrations, wind energy, and the like, which were discussed with referenced to FIGS. 1A-1B. As discussed, the energy harvester 725, with reference to harvesting energy from RF wireless signals, may be a multi-band harvester in being configured to harvest energy from multiple ranges of frequencies that define different RF bands. In these embodiments, the energy harvester 725 is also configured to store the harvested energy within the energy cells 728, which then operate as a power source for the wireless device 700.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
transmitting, by an anchor wireless device over a first radio frequency (RF) band, a first wireless signal to a client wireless device, wherein the client wireless device is an ambient power (AMP) device that harvests environmental energy, and wherein the first wireless signal includes a data packet requesting information from the client wireless device; and
receiving, by the anchor wireless device over a second RF band, a second wireless signal from the client wireless device, wherein the second wireless signal includes a data packet responding with the requested information.

2. The method of claim 1, wherein one of:
the second RF band operates at a lower frequency range than that of the first RF band;
the second RF band operates at a higher frequency range than that of the first RF band; or
the first RF band is the same as the second RF band.

3. The method of claim 1, further comprising generating the first wireless signal and the second wireless signal with technology comprising one of Wi-Fi®, Bluetooth®, Bluetooth® Low Energy, Ultra-Wideband, Z-Wave™, Zigbee®, LoRa™, or Wi-SUN®.

4. The method of claim 1, wherein the anchor wireless device comprises one of an access point, a router, or a mobile hotspot device, and wherein the client wireless device is a wireless identification tag.

5. The method of claim 1, wherein the requested information is one of an identification of the client wireless device, a location of the client wireless device, temperature data, humidity data, pressure data, level data, or data associated with an environment of the client wireless device.

6. The method of claim 1, wherein the first wireless signal is also an energizing RF signal from which the client wireless device harvests energy.

7. The method of claim 1, further comprising transmitting, by the anchor wireless device, an energizing RF signal towards the client wireless device from which the client wireless device harvests energy, wherein the energizing RF signal is transmitted over one of the first RF band, the second RF band, or a third RF band.

8. The method of claim 1, further comprising transmitting, by a second anchor wireless device, an energizing RF signal towards the client wireless device from which the client wireless device harvests energy, wherein the energizing RF signal is transmitted over one of the first RF band, the second RF band, or a third RF band.

9. The method of claim 1, further comprising transmitting, by a second anchor wireless device, an energizing RF signal towards the client wireless device from which the client wireless device harvests energy, wherein the energizing RF signal is transmitted as a continuous wave (CW) or using technology comprising one of Bluetooth®, Bluetooth® Low Energy, Wi-Fi®, or Zigbee®.

10. A wireless network comprising:
an anchor wireless device to transmit, over a first radio frequency (RF) band, a first wireless signal comprising a data packet requesting information; and
a client wireless device to:
harvest energy from an environment of the client wireless device;
receive the first wireless signal and parse the data packet; and
transmit, over a second RF band, a second wireless signal to the anchor wireless device, wherein the second wireless signal includes a data packet responding with the requested information.

11. The wireless network of claim 10, wherein one of:
the second RF band operates at a lower frequency range than that of the first RF band;
the second RF band operates at a higher frequency range than that of the first RF band; or
the first RF band is the same as the second RF band.

12. The wireless network of claim 10, wherein:
the anchor wireless device is further to generate the first wireless signal with technology comprising one of Wi-Fi®, Bluetooth®, Bluetooth® Low Energy, Ultra-Wideband, Zigbee®, LoRa™, or Wi-SUN®; and
the client wireless device is further to generate the second wireless signal with technology comprising one of Wi-Fi®, Bluetooth®, Bluetooth® Low Energy, Ultra-Wideband, Z-Wave™, Zigbee®, LoRa™, or Wi-SUN®.

13. The wireless network of claim 10, wherein the anchor wireless device comprises one of an access point, a router, or a mobile hotspot device, and wherein the client wireless device is a wireless identification tag.

14. The wireless network of claim 10, wherein the requested information is one of an identification of the client wireless device, a location of the client wireless device, temperature data, humidity data, pressure data, level data, or environmental-related data associated with the environment of the client wireless device.

15. The wireless network of claim 10, wherein the first wireless signal is also an energizing RF signal, and wherein the client wireless device is to harvest energy from the first wireless signal.

16. The wireless network of claim 10, wherein
the anchor wireless device is further to transmit, towards the client wireless device, an energizing RF signal, wherein the energizing RF signal is transmitted over one of the first RF band, the second RF band, or a third RF band; and
the client wireless device is to harvest energy from the energizing RF signal.

17. The wireless network of claim 10, further comprising:
a second anchor wireless device to transmit, towards the client wireless device, an energizing RF signal, wherein the energizing RF signal is transmitted over one of the first RF band, the second RF band, or a third RF band; and
wherein the client wireless device is to harvest energy from the energizing RF signal.

18. The wireless network of claim 10, further comprising:
a second anchor wireless device to transmit, towards the client wireless device, an energizing RF signal, wherein the energizing RF signal is transmitted as a continuous wave (CW) or using technology comprising one of Bluetooth®, Bluetooth® Low Energy, Wi-Fi®, or Zigbee®; and
wherein the client wireless device is to harvest energy from the energizing RF signal.

19. The wireless network of claim 10, wherein the client wireless device is to harvest energy from one of RF-related power sources or non-RF-related power sources.
